(19) United States
(12) Patent Application Publication
(10) Pub. No.: US 2008/0004737 A1
(43) Pub. Date: Jan. 3, 2008

(54) Computerized engineering design and operating system

(76) Inventor: Frank L. Bennardo, Deerfield Beach, FL (US)

Correspondence Address: Mark D. Bowen;Stearns Weaver Miller, et al., Suite 2100, 200 East Las Olas Boulevard, Fort Lauderdale, FL, 33301, US

(21) Appl. No.: 11/824,195

(22) Filed: Jun. 29, 2007

Related U.S. Application Data
(60) Provisional application No. 60/817,862, filed on Jun. 30, 2006.

(51) Int. Cl. G06F 19/00

(52) U.S. Cl. 700/97

(57) ABSTRACT

A computerized engineering design and project data collection and processing system adapted for use over a global computer network, such as the Internet, includes initial data collection and job input modules, project type selection modules, graphic user interface engineering calculators, project management, accounting, and scheduling modules. The system includes computer applications that perform engineering calculations in the form of graphical interface calculators developed using interactive data visualization interfaces adapted with progressive input which customize the calculator based on input scenario. The interactive software application interfaces with a spreadsheet application to import data and formulas, and output interactive animated charts, graphs, and engineering solutions to simple and complex engineering problems. The system is capable of roducing output solutions suitable for approval and sealing by a registered engineer or other approving agent. An overall operations system functions to control contract management, job tracking and coordination, accounting, scheduling, project templates and detail drawings, project tools (including calculators), and plan processing services including approval, sealing, copying, and automated shipping functions. In an alternate embodiment, the system is configured as a network wherein engineering services including engineering design, calculations, and materials reports are provided to customers by remotely located computerized kiosks.

### CROSS REFERENCE TO RELATED APPLICATIONS

This application claims the benefit of provisional U.S. Patent Application No. 60/817,862, filed Jun. 30, 2006.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to engineering design systems, and more particularly to a computerized engineering design and operating system.

2. Description of Related Art

Advancements in computer power and computer-to-computer communications have led to increased use of computers in engineering design. Computers have now transformed engineering design. Personal computers running engineering software provide engineers with significant advances that result in improved analysis and problem solving. Computer-aided design (“CAD”) systems have contributed to similar advances in engineering design and drafting. In the field of engineering where analysis is an important aspect of design the integration of computers is now well established. Further, the influx of computer technology into society in general, and the filed of engineering specifically, is revolutionary and now ripe to provide further significant advances and benefits.

The prior art reveals a number of complex computerized engineering systems designed to harness computer technology to benefit engineers and engineering design. For example, U.S. Pat. No. 5,557,710, issued to Amdursky et al., discloses in a computer aided design system in which a mechanical quantity of a structure can be determined from stored geometrical representation of the structure, the material properties thereof, and the loads imposed thereon. U.S. Patent No. 6,132,108, issued to Kashiwamura et al., discloses an engineering design system for designing structures that display complicated non-linear behavior. U.S. Pat. No. 6,763,324, issued to Pittman et al., discloses a system and design process that utilizes a multiple of computer models that are executed by individual solver programs, and an executive code that manages the computer models and the feedback of the solution results from the computer models to obtain a solution whereby interrelated parameters are accounted for. U.S. Pat. No. 6,922,701, issued to Ananian et al., discloses a method for generating an interactive profile of a structure, such as a building, employing an interactive profile system that preferably utilizes an Internet web browser to interface with a user.

A comprehensive data warehouse computing system is disclosed in U.S. Pat. No. 7,003,560, issued to Mullen et al. Mullen discloses a data warehouse computing system including a server connected to a client, a data warehouse architecture, metadata management, a population architecture, an end-user access architecture, an operations architecture, and a development architecture. The operations architecture includes a server connected with a client, a software distribution tool, a configuration and asset management tool, a fault management and recovery management tool, a capacity planning tool, a performance management tool, a license management tool, a remote management tool, an event management tool, a systems monitoring and tuning tool, a security tool, a user administration tool, a production control application set, and a help desk tool. The development architecture includes a process management tool, a personal productivity tool, a quality management tool, a system building tool, an environment management tool, a program and project management tool, a personal productivity tool and an information management tool.

Patent Application Publication No. 2005/0216429, to Hertz, discloses a process that converts stand-alone data sources to an open standard based architecture and integrates data throughout disparate departments and organizations for creating a collaborative environment via Web-based applications without requiring that the data come under the control of a central database. Patent Application Publication No. 2006/0080279, to Jones, discloses a complex customized and customizable structural calculation and project detailing system that is capable of producing a submittal package in connection with structures incorporating cold-formed structural members. Patent Application Publication No. 2006/0064288, to Ferryanto, discloses a system for interactive design a product having a design solution which includes a design parameter and a design response using a user computer system and a remotely located computer system in communication with the user computer system. The system also includes a computer-generated geometric model of a product design stored in a data storage means. Statistical analysis software implemented by the remotely located computer system and a computer aided engineering software program implemented by the remotely located computer system are used. The method is implemented by an executable product design software program, and includes the steps of identifying an ideal design solution for the product design by identifying an unnecessary design parameter having a predetermined significant influence on a variable design response and fixing a predetermined nominal value of the identified unnecessary design parameter at which the variable design response is a minimum and the product design is an uncoupled design or a decoupled design.

While the systems and methods disclosed in the art appear generally suited for the limited goals they report to accomplish, there remains a need in the art for an improved computer engineering design and operating system that overcomes the limitations and shortcomings present in the art.

### BRIEF SUMMARY OF THE INVENTION

The present invention overcomes the disadvantages present in the art by providing a comprehensive computerized engineering design and project data collection and processing system. A computerized engineering design system in accordance with the present invention is preferably adapted for use over a global computer network, such as the Internet, and includes initial data collection and job input modules, project type selection modules, graphic user interface engineering calculators, project management, accounting, and scheduling modules. In accordance with the preferred embodiment, the system is built around computer applications that perform engineering calculations (hereinafter “calculators”) using a method that relies on interactive data visualization interfaces adapted with progressive input which customizes the calculator based on input scenario. The calculators are preferably operationally structured using an interactive software application that uses a visual modeling bridge that bridges the gap between data analysis and visual presentation. The interactive software application interfaces with a spreadsheet application to import data and formulas and output interactive animated charts, graphs, that provide the graphical user interface for the calculators. The present invention contemplates a system that provides various engineering fields, such a structural, mechanical, and electrical engineering, with simple and easy to use calculators that are capable of producing output solutions suitable for approval and sealing by a registered engineer or other approving agent. The present invention thus provides a system wherein complex engineering calculations may be accurately performed by non-engineers by providing basic criteria and responding to simple prompts. The calculators may be incorporated into an overall operations system that includes, contract management, job tracking and coordination, accounting, scheduling, project templates and detail drawings, project tools (including calculators), and plan processing services including approval, sealing, copying, and automated shipping functions. In an alternate embodiment, the system is configured as a network wherein engineering services including engineering design, calculations, and materials reports are provided to customers by remotely located computerized kiosks.

Accordingly it is an object of the present invention to provide an improved computerized engineering design system.

Another object of the present invention is to provide such a system that incorporates computerized engineering calculators developed using an interactive software application that interfaces with a spreadsheet application to import data and formulas and output interactive animated calculators.

Still another object of the present invention is to provide such a system that allows non-engineers to quickly and accurately solve complex engineering problems using computerized calculators that effectively guide the user through the calculation using simple, easy to understand prompts.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a flow chart for an engineering calculator according to the present invention;

FIGS. 2A-2D depict a simple Adhesive Cartridge Volume Calculator in accordance with the present invention;

FIGS. 3A and 3B depict a Component & Cladding Pressure Calculator;

FIGS. 4A-4H depict a Footing Uplift Sizing Calculator illustrating progressive input that customizes the calculator based on input scenarios;

FIGS. 5A and 5B depict an Aluminum Screen Wall Calculator illustrating design solutions that are approved (OK) and not approved (NOT OK) respectively; and

FIG. 6 is a block diagram for a comprehensive computerized engineering design system in accordance with the present invention.

### DETAILED DESCRIPTION OF THE INVENTION

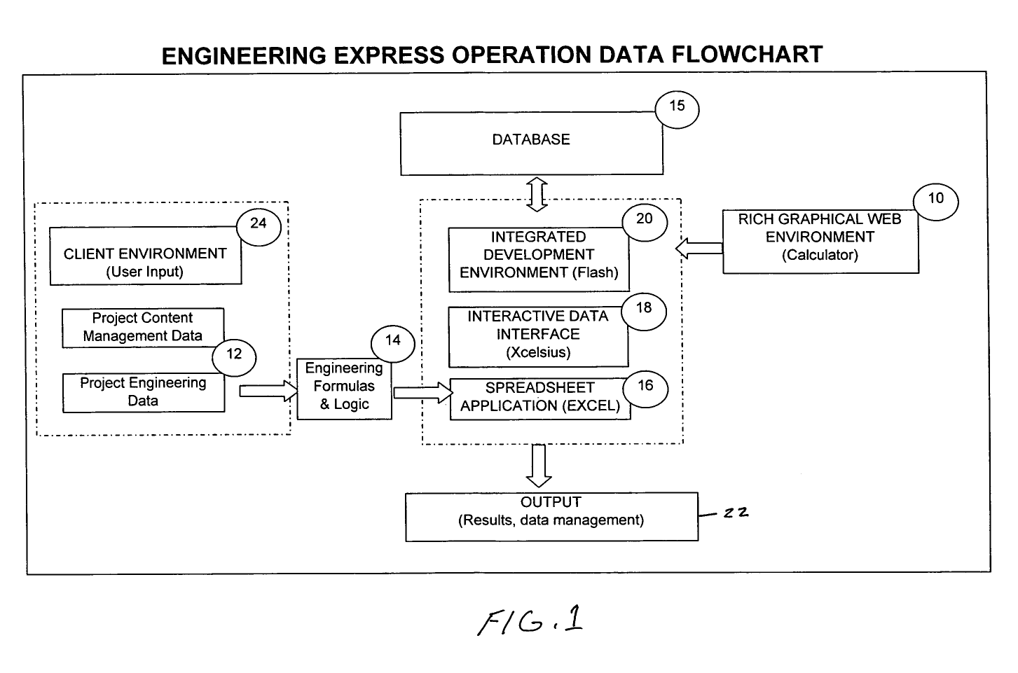

With reference now to the drawings, FIGS. 1-6 illustrate a computerized engineering design and project management system that operates over a global computer network (e.g. the Internet). In accordance with a broad embodiment, a system in accordance with the present invention provides a comprehensive computerized engineering design system that provides a password protected account system and access portal that provides for individual user access to view, work on, and manage specific project(s). This embodiment, thus provides a generally full service computerized engineering system adapted to handle multiple users, each with multiple accounts and projects, to provide a source of automated engineering calculation and design services. In accordance with a narrower embodiment, a system in accordance with the present invention provides engineering solutions to user's in a simple easy to use format wherein engineering formulas and data embodied in spreadsheet format are processed using a stand-alone interface application into an interactive visual data presentation that prompts and guides the user through input to final result. This embodiment thus provides a simple interactive means of completing complex engineering calculations that can result in approved results suitable for submission to local government agencies as part of the engineering design and approval process.

FIG. 1 is a flowchart illustrating an engineering calculator, generally referenced as 10, for use in accordance with a computerized engineering design system of the present invention. Engineering calculator 10 functions to as an interactive software application that interfaces data 12 and engineering formulas 14 and logic using a spreadsheet application 16. Data 12 preferably comprise any suitable technical data, including mechanical, electrical, or structural properties of specific materials and structures. Formulas 14 preferably comprise engineering formulas, such as formulas used to calculate stress, strain, wind loading, or any other engineering related solution. Data 12 and formulas 14 are preferably combined in spreadsheet format using a spreadsheet application 16, such as Microsoft EXCEL®, to provide an engineering solution to a particular engineering problem. EXCEL is a registered trademark of Microsoft Corporation, Seattle, Wash. Spreadsheet files are preferably stored in a database 15.

An interactive data interface application 18 interfaces spread sheet application 16 with an integrated development environment 20. Interactive interface application 18 preferably comprises an interactive data visualization program identified as XCELSIUS®. XCELSIUS is a registered trademark of Business Objects Americas, San Jose, Calif. XCELSIUS comprises computer software for use in creating and manipulating databases and preparation of visual materials while providing access to those databases and visual materials via the Internet. Integrated development environment 20 preferably comprises a FLASH® application. Adobe Flash, or simply Flash, refers to both the Adobe Flash Player, and to the Adobe Flash Professional multimedia authoring program. FLASH® is a registered trademark of Adobe Systems Corporation, San Jose, Calif. Integrated development environment 20 comprises a computer software application for creating and playing animation, sound, graphics, and the like. A client environment 24 is provided to allow for user input, and output representing engineering solutions is presented by suitable output hardware 22, such as an electronic display and/or printer.

As should be apparent a calculator 10 may be developed to solve virtually any engineering problem. By combining a computerized system using a simple spreadsheet application to import data and formulas and output interactive animated charts, graphs, the present invention provides simple solutions to complex engineering problems. A further significant aspect of calculators 10 developed in accordance with the present invention involves using a method of interactive data visualization adapted with progressive input which customizes the calculator based on input scenario. The calculators are created with a combination of math calculations and logic to provide a fully interactive environment designed to walk the user through a variety of options to achieve a solution. Each calculator may contain a variety of dials, sliders, and entry boxes tied to the engineering calculations (in Microsoft EXCEL) that allows the user to interact with the options to analyze an engineering design scenario. Many scenarios can be modeled using a single calculator, depending on the options and values selected by the user.

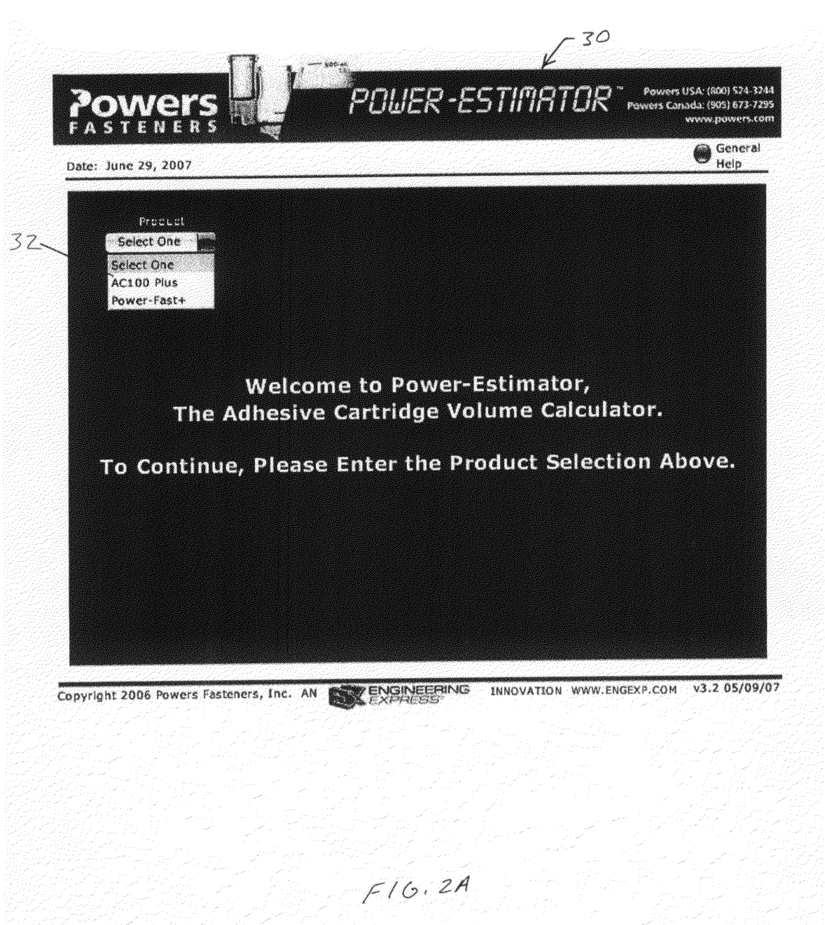

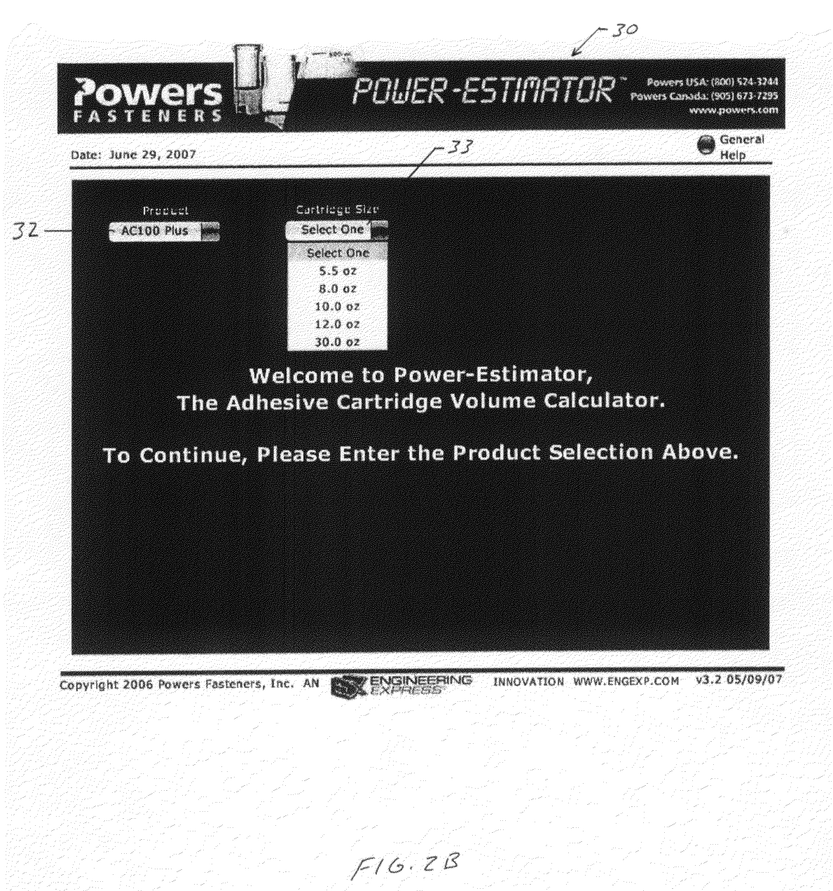

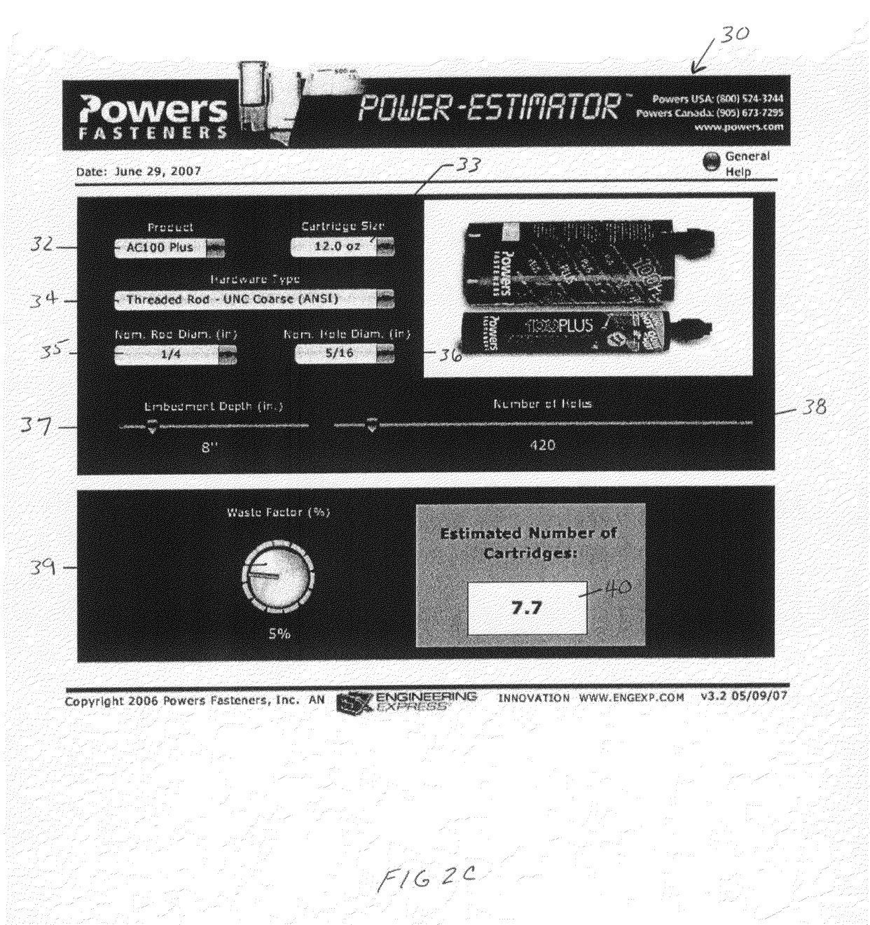

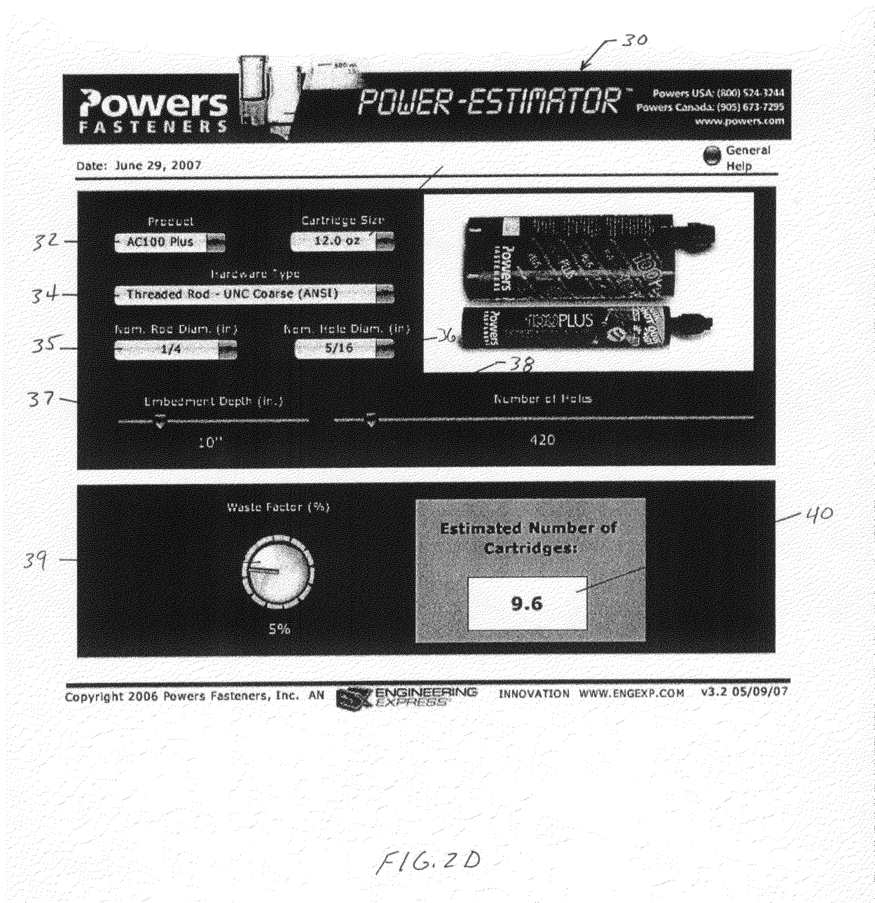

FIGS. 2-5 provide examples of various engineering calculators developed in accordance with a computerized engineering design and project management system of the present invention. FIGS. 2A-2D, depict computer screen displays for a simple Adhesive Cartridge Volume Calculator, generally referenced as 30, in accordance with the present invention. Calculator 30 is useful in estimating the number of adhesive cartridges needed for a project based on user input of a number of factors such as product type, cartridge size, hardware type, nominal rod diameter, nominal hole diameter, embedment depth, number of holes, and waste factor. As best seen in FIG. 2A a product selection field 32 prompts the user to select a product type. Next, a cartridge selection field 33, which is dependent on the input in product selection field 32 prompts the user to select an available cartridge size as shown in FIG. 2B. FIGS. 2C and 2D illustrate alternate solutions to the cartridge number estimate. Turning first to FIG. 2C, user input fields are provided for hardware type 34, nominal rod diameter 35, nominal hole diameter 36, embedment depth 37, number of holes 38, and waste factor 39. Based on the input seen in FIG. 2C, the calculator displays a solution, namely an estimate of 7.7 cartridges, in display 40. The user may quickly adjust any of the input parameters to achieve an alternate solution as seen in FIG. 2D wherein the embedment depth is increased from 8 in. (FIG. 2C) to 10 in. thereby resulting in an alternate solution of 9.6 estimated cartridges.

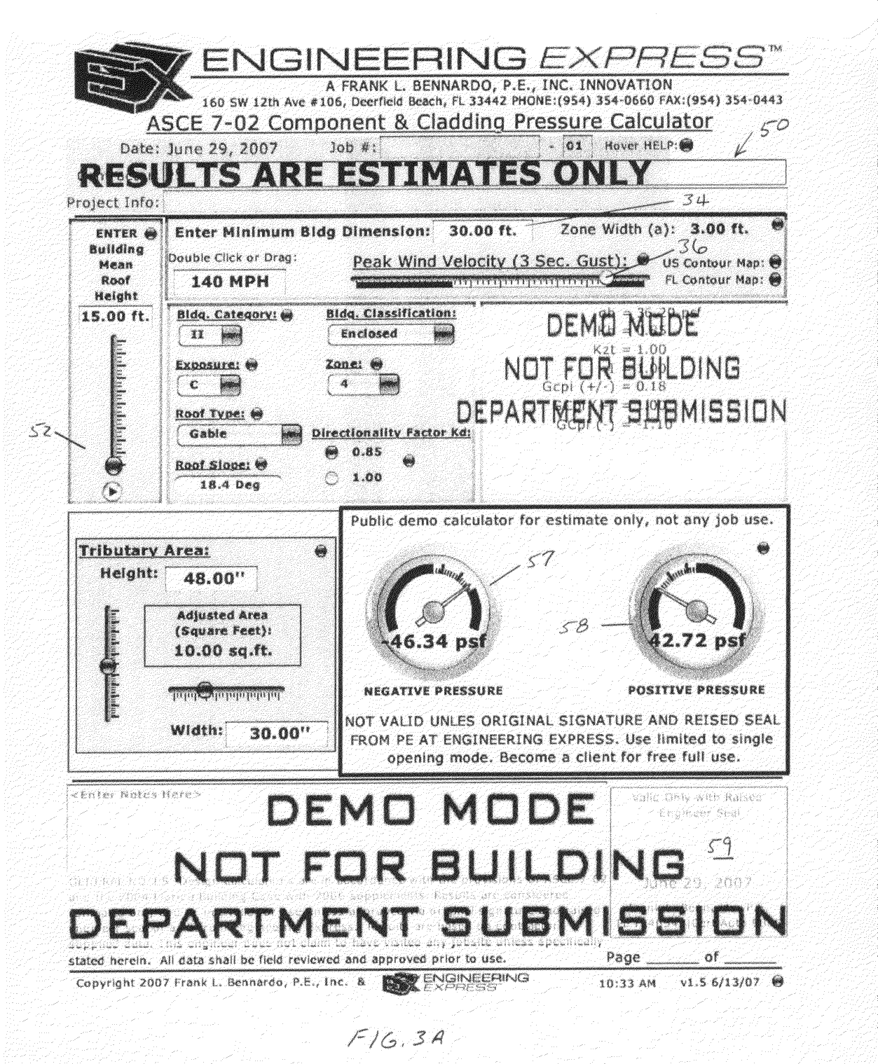

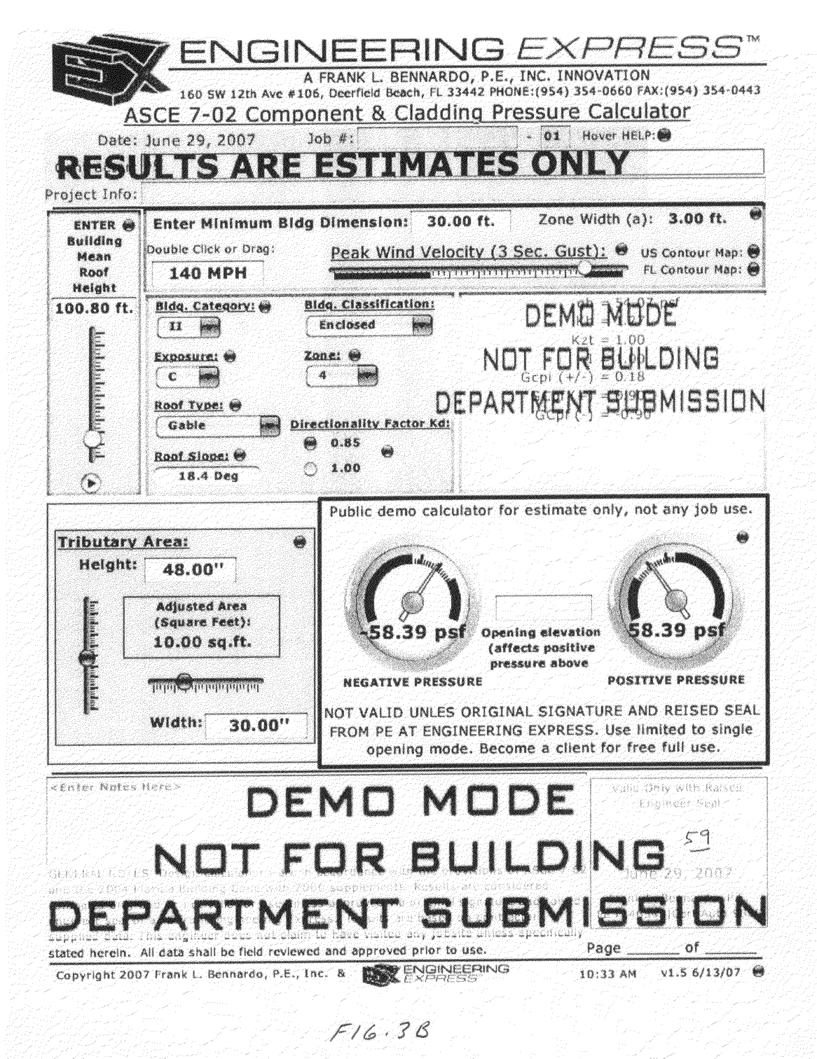

FIGS. 3A and 3B illustrate screen displays for a demonstration calculation for an ASCE 7-98 Wall Component & Cladding Pressure Calculator, generally referenced as 50. Calculator 50 includes heading and information content fields for identifying general information such as the date, contractor, and project information. In accordance with this particular calculator, user prompted input fields are provided for design factors such as building mean roof height 52 (slider), minimum building dimension 54, and peak wind velocity 56 (slider). A significant advantage realized by interface of spread sheet applications with an integrated development environment using an interactive data interface in accordance with the present invention allows for a user friendly graphical user interface wherein variables, may be adjusted by manipulating slider bars, dials, and other animated input features. For example, the user may quickly adjust the peak wind velocity by adjusting a corresponding slider bar 56. Adjustment of any one parameter results in effectively real-time recalculation and output of the engineering solution represented in this calculator by negative pressure dial 57 and positive pressure dial 58. FIG. 3A depicts a solution for a building wherein the mean roof height is set at 15 ft. using slider 52, thereby resulting in a negative pressure solution of −46.34 pounds per square foot (“psf”) illustrated on output dial 57, and a positive pressure solution of 42.72 psf illustrated on output dial 58. FIG. 3B depicts an alternate solution for a building wherein the mean roof height is adjusted upward to 100.8 ft. using slider 52 thereby resulting in a negative pressure solution of −58.39 psf illustrated on output dial 57, and a positive pressure solution of 58.39 psf illustrated on output dial 58. Calculator 50 is further adapted with a space, referenced as 59, for receiving a raised engineering seal confirming approval by a professional engineer.

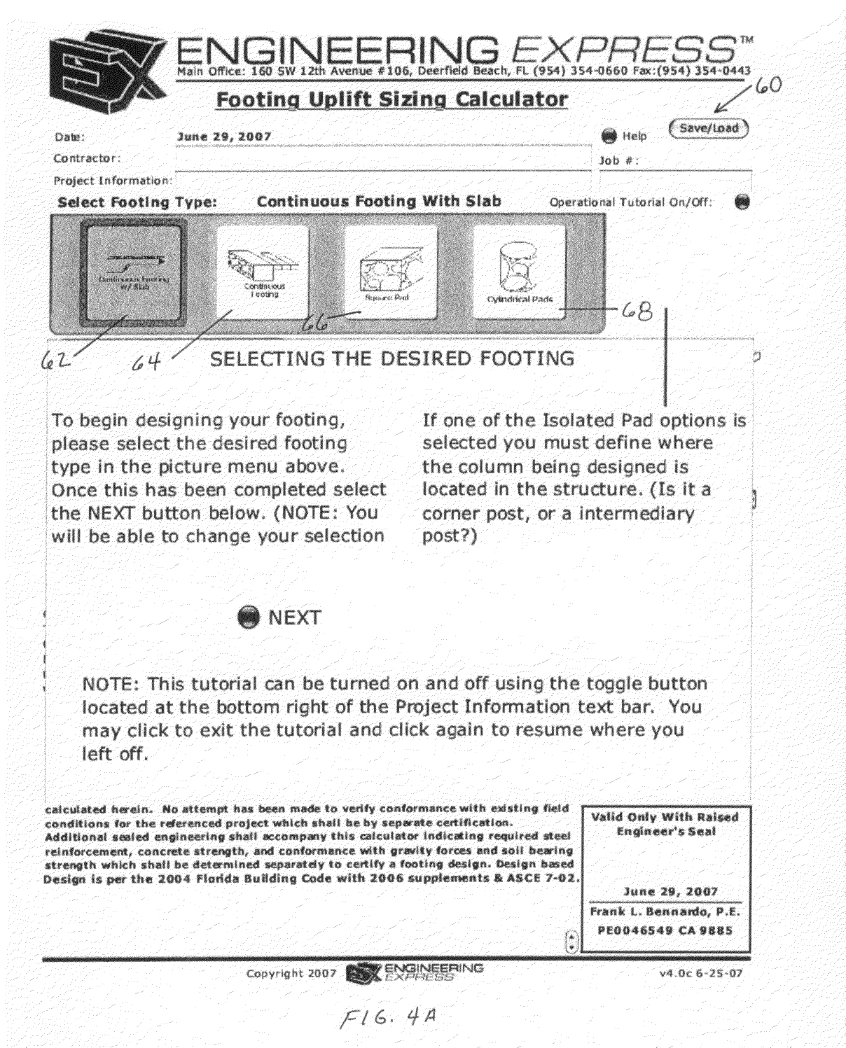

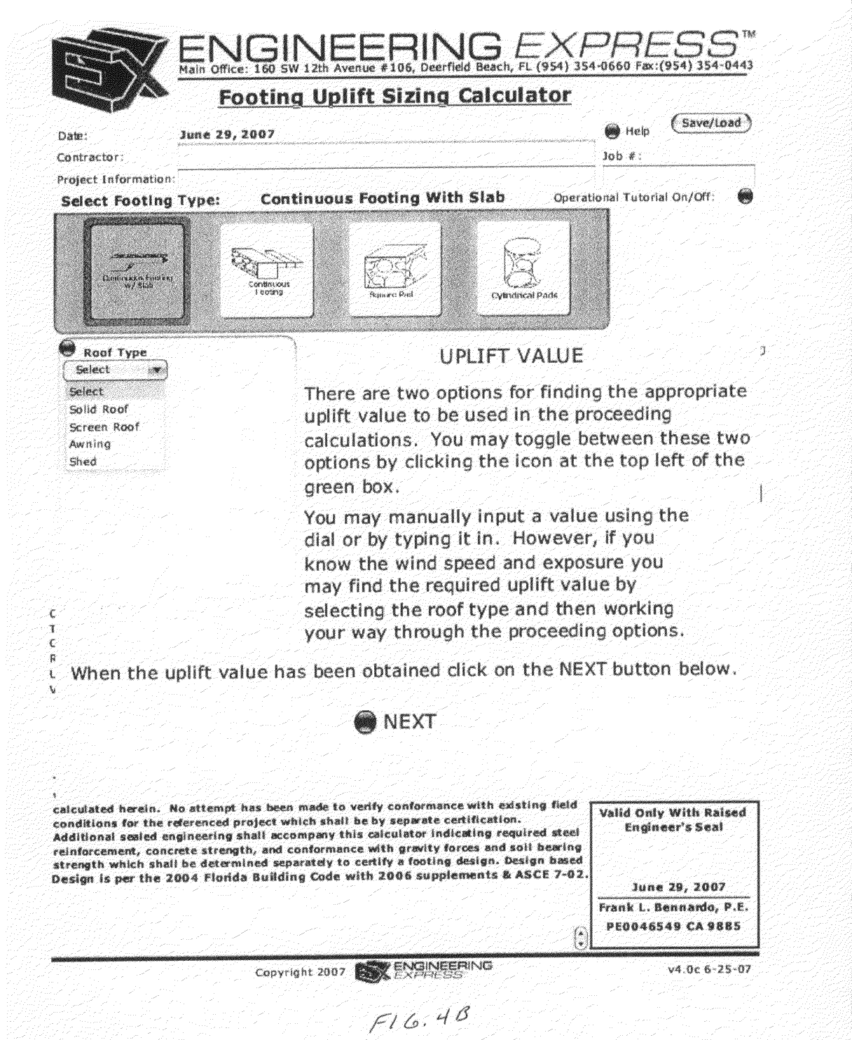

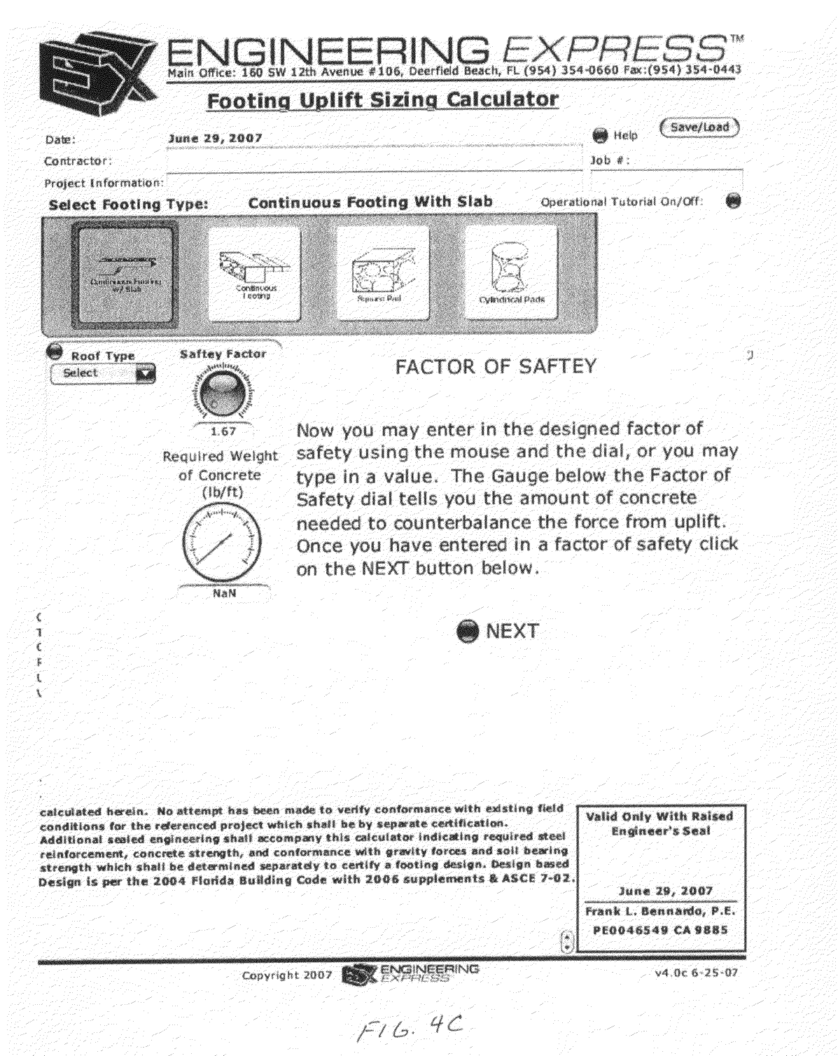

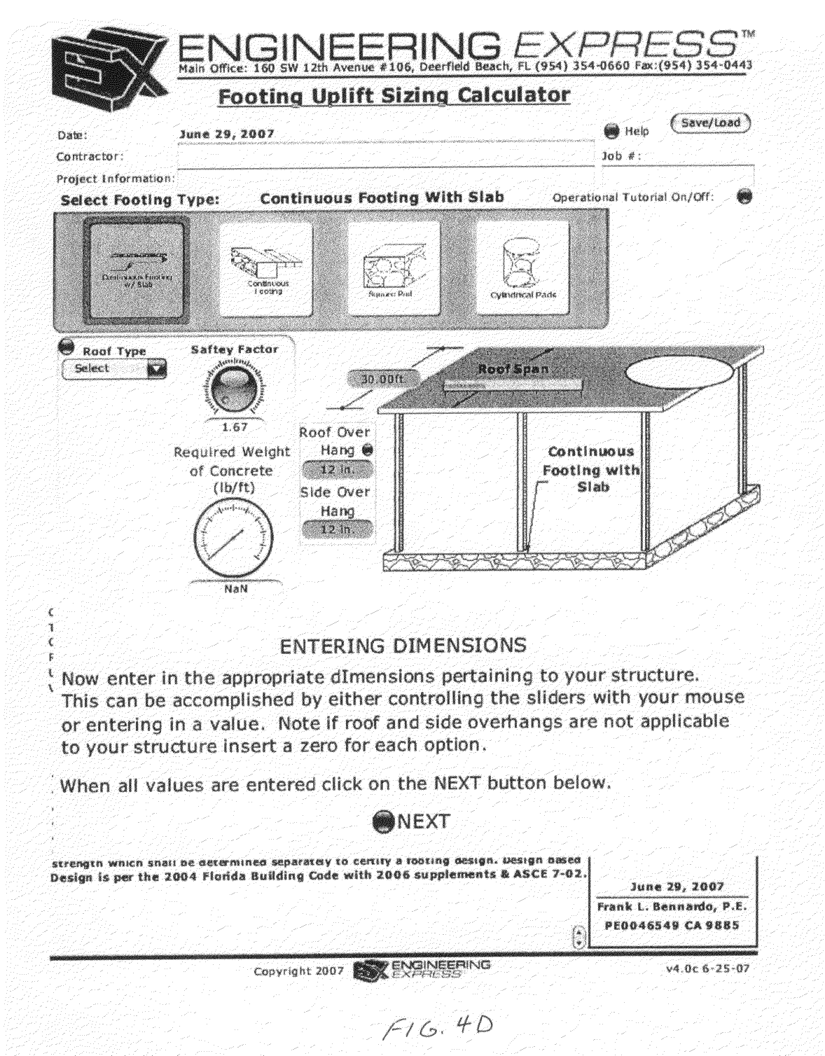

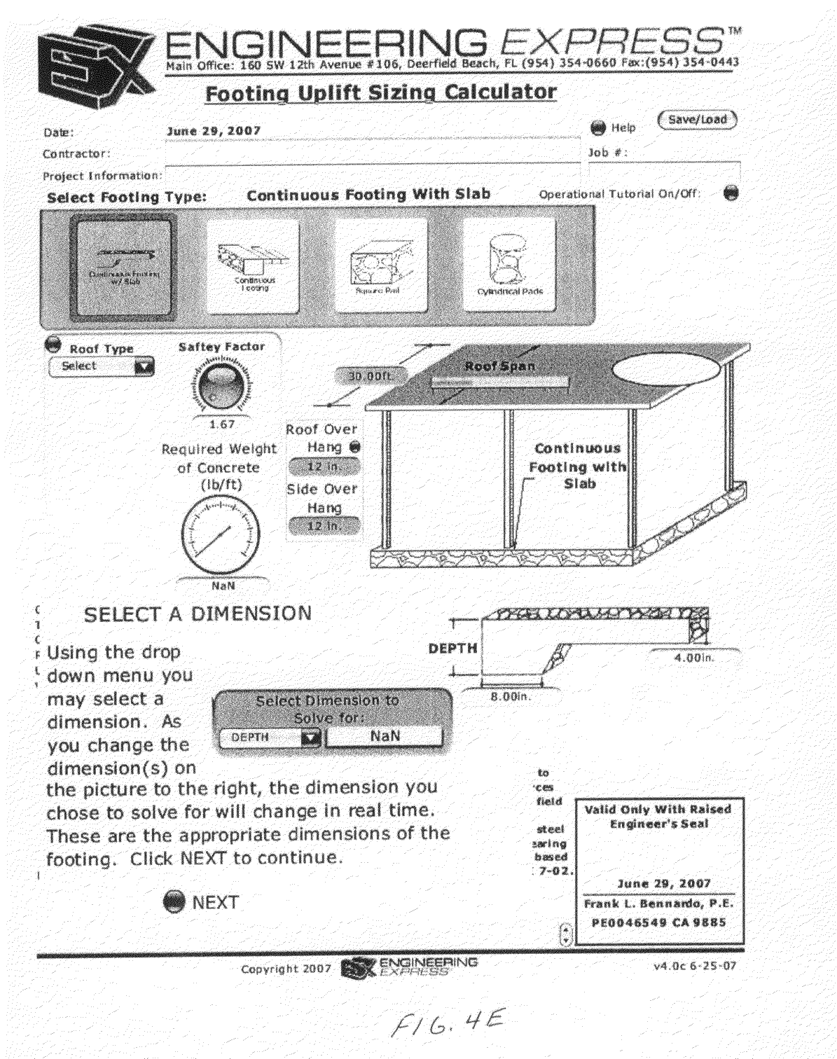

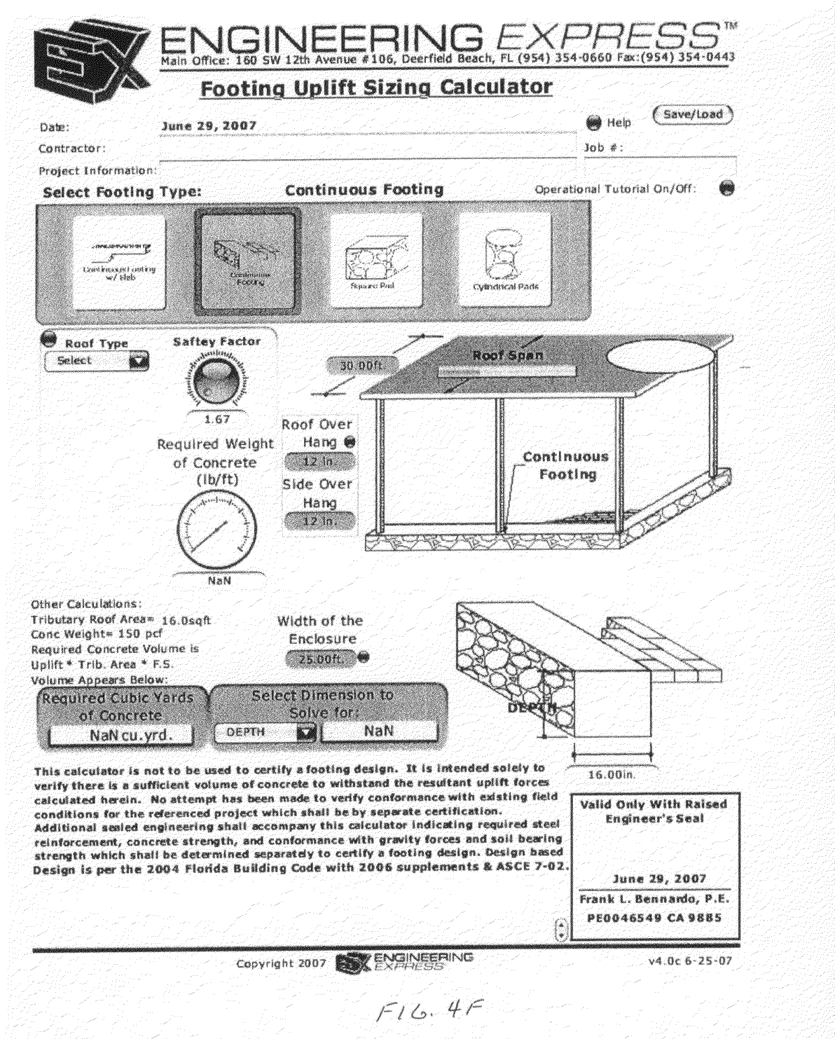

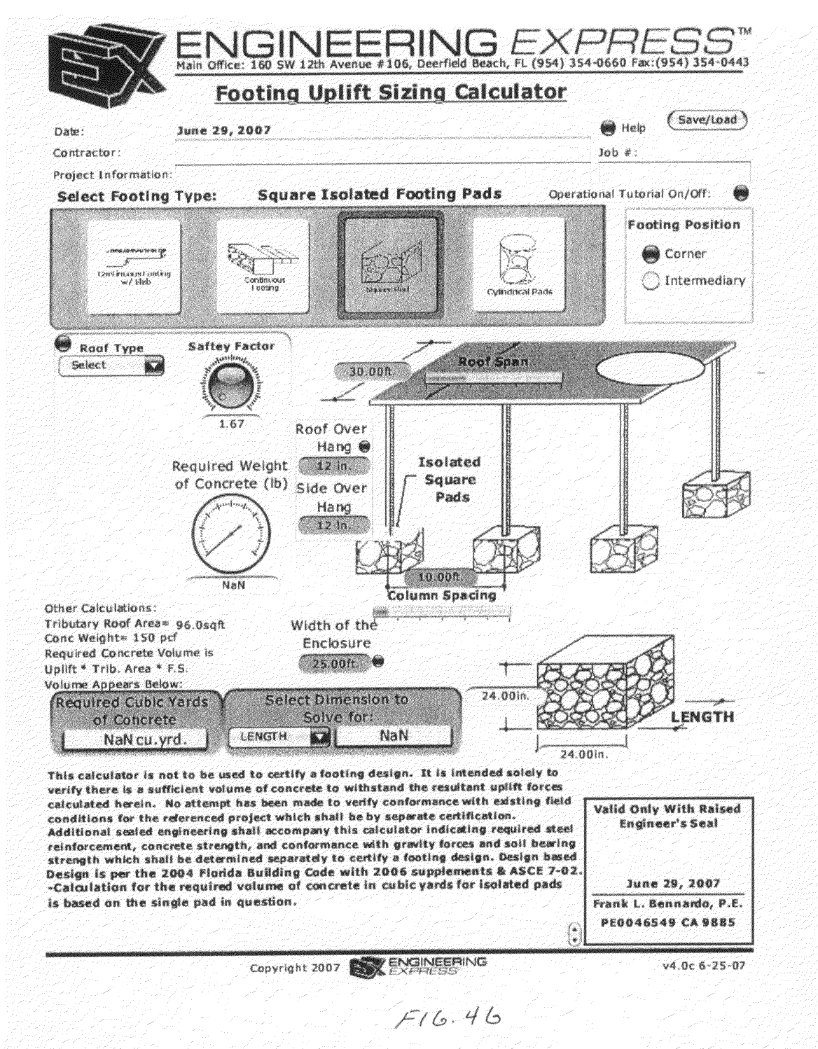

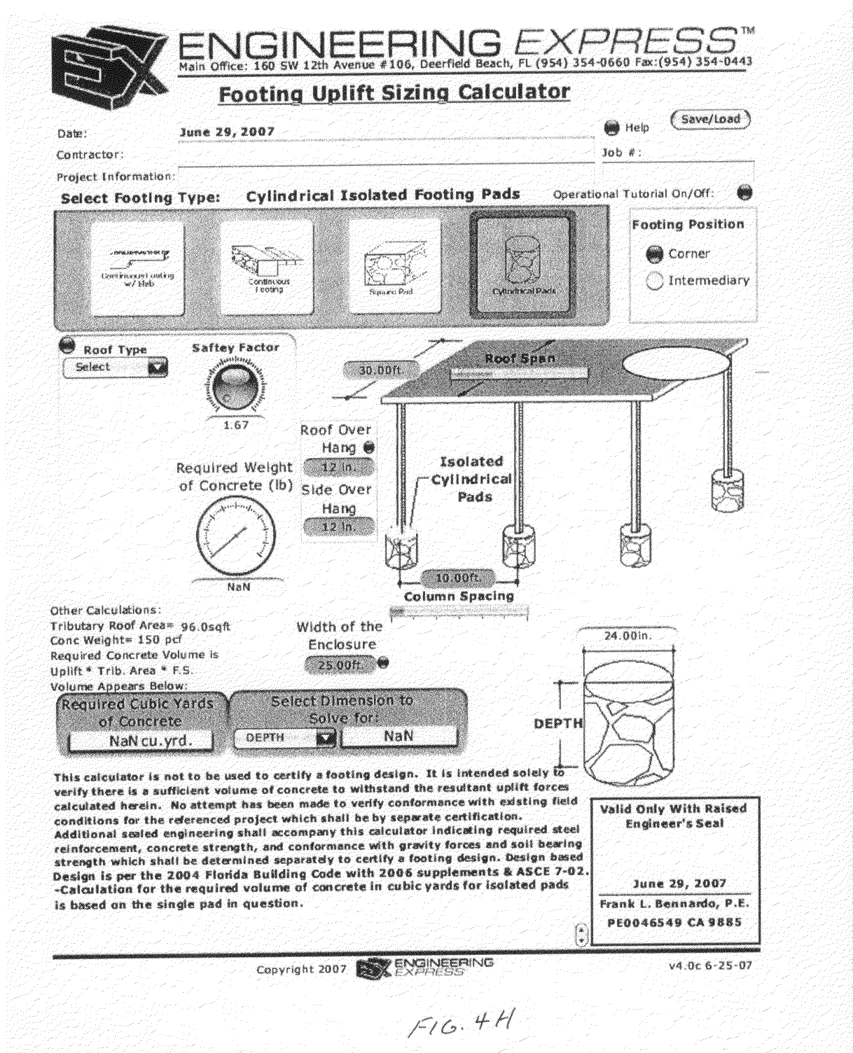

FIGS. 4A-4H depict a Footing Uplift Sizing Calculator, generally referenced as 60, illustrating progressive input that customizes the calculator based on input scenarios. FIG. 4A illustrates alternate input options for footing type, including continuous footing with slab 62, continuous footing 64, square pad 66, and cylindrical pads 68. Selection of a particular footing type customizes future calculator screens, options, and input fields. FIG. 4B illustrates the prompt for uplift value. FIG. 4C illustrates the prompt for factor of safety. FIG. 4D illustrates the prompt for entering dimensions. FIG. 4D illustrates the prompt for selecting dimensions for a continuous footing with slab option 62. FIG. 4F illustrates the dimension prompts for selection dimensions for the continuous footing option 64. FIG. 4G illustrates the dimension prompts for selecting dimensions for a square pad option 66. FIG. 4H illustrates the dimension prompts for selecting dimensions for the cylindrical pads option 68. As should now be apparent, calculators developed in accordance with the present invention may incorporate progressive input that customizes the calculator based on user input and alternative design selections.

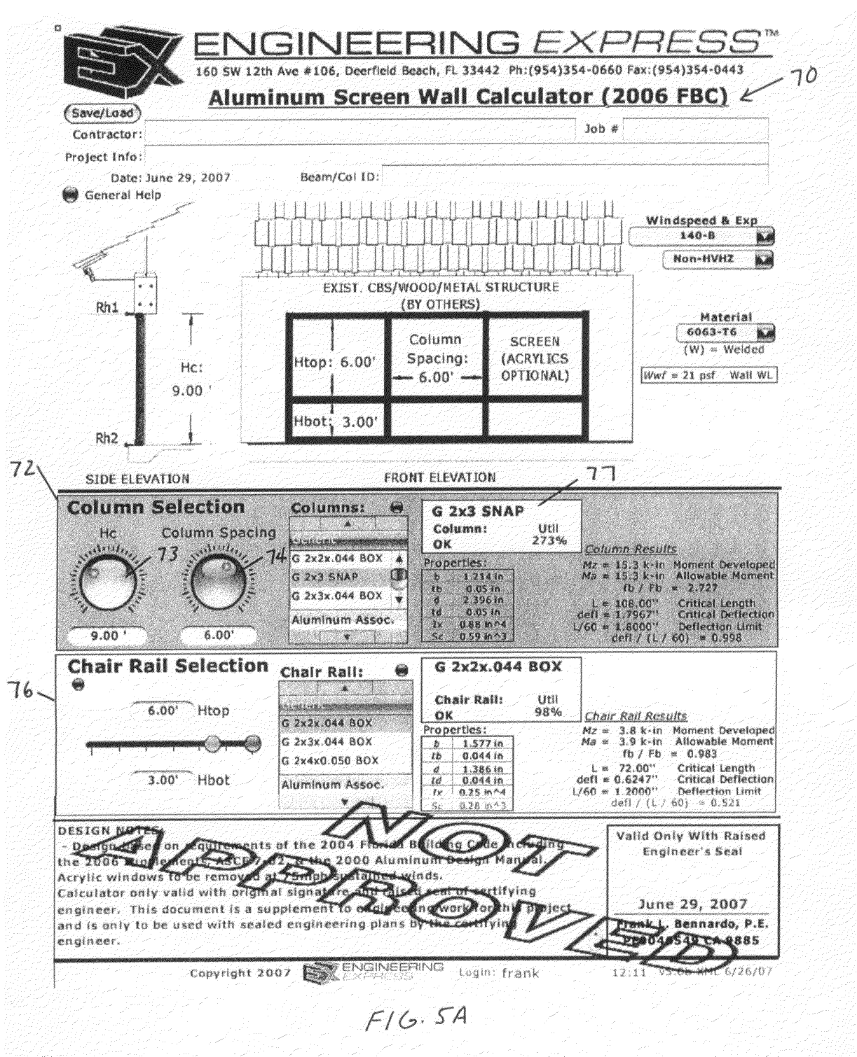

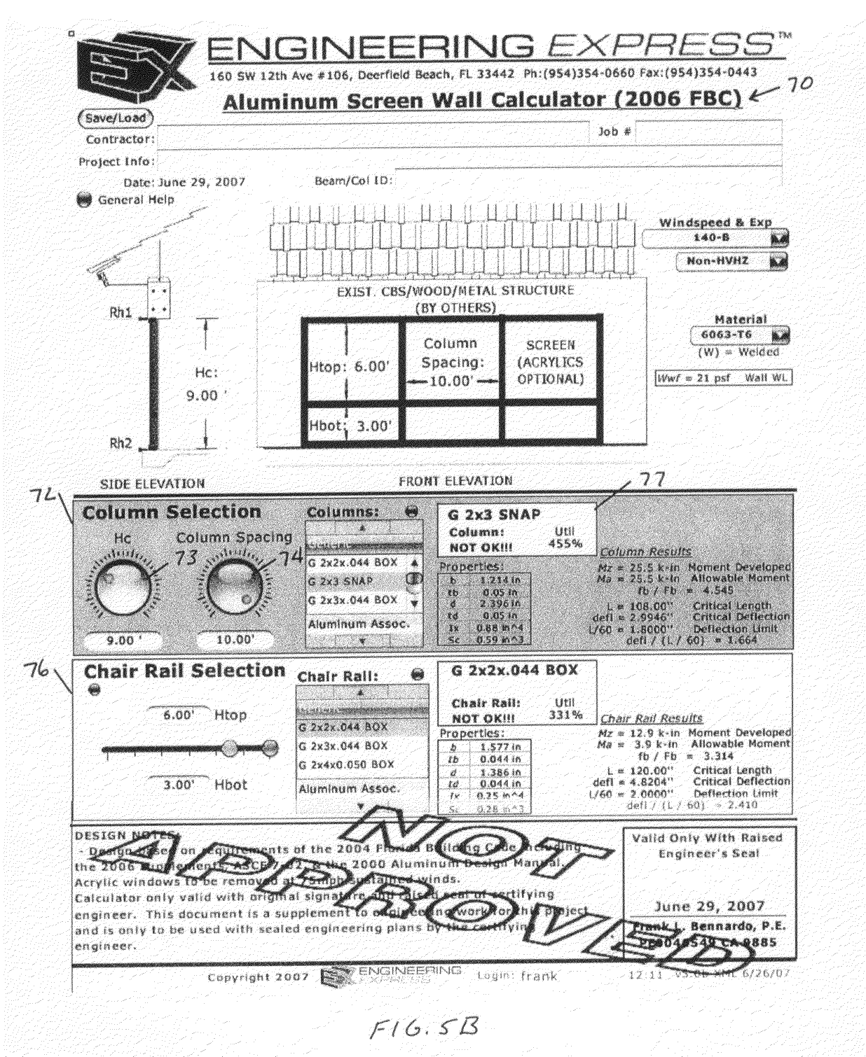

FIGS. 5A and 5B depict an Aluminum Screen Wall Calculator, generally referenced as 70, illustrating design solutions that are approved (OK) and not approved (NOT OK) respectively. With reference to FIG. 5A there is depicted an Aluminum Screen Wall Calculator wherein input parameters result in an approved solution. More particularly, calculator 70 includes input options including a column selection 72 and a chair rail selection 76. Column selection 72 allows the user to adjust column height and spacing using dials 73 and 74 respectively. Chair rail selection allows the user to adjust chair rail parameters. As should be apparent, other parameters including design wind speed, exposure, material, etc. are also incorporated. FIG. 5A illustrates a solution for a design having a column spacing of 6-ft., which design has been determined to fall within acceptable design parameters as evidenced by the “OK” generated in output box 77. On the other hand, FIG. 5B illustrates a solution for a design having a column spacing of 10-ft., which design has been determined not to fall within acceptable design parameters as evidenced by the “NOT OK” generated in output box 77.

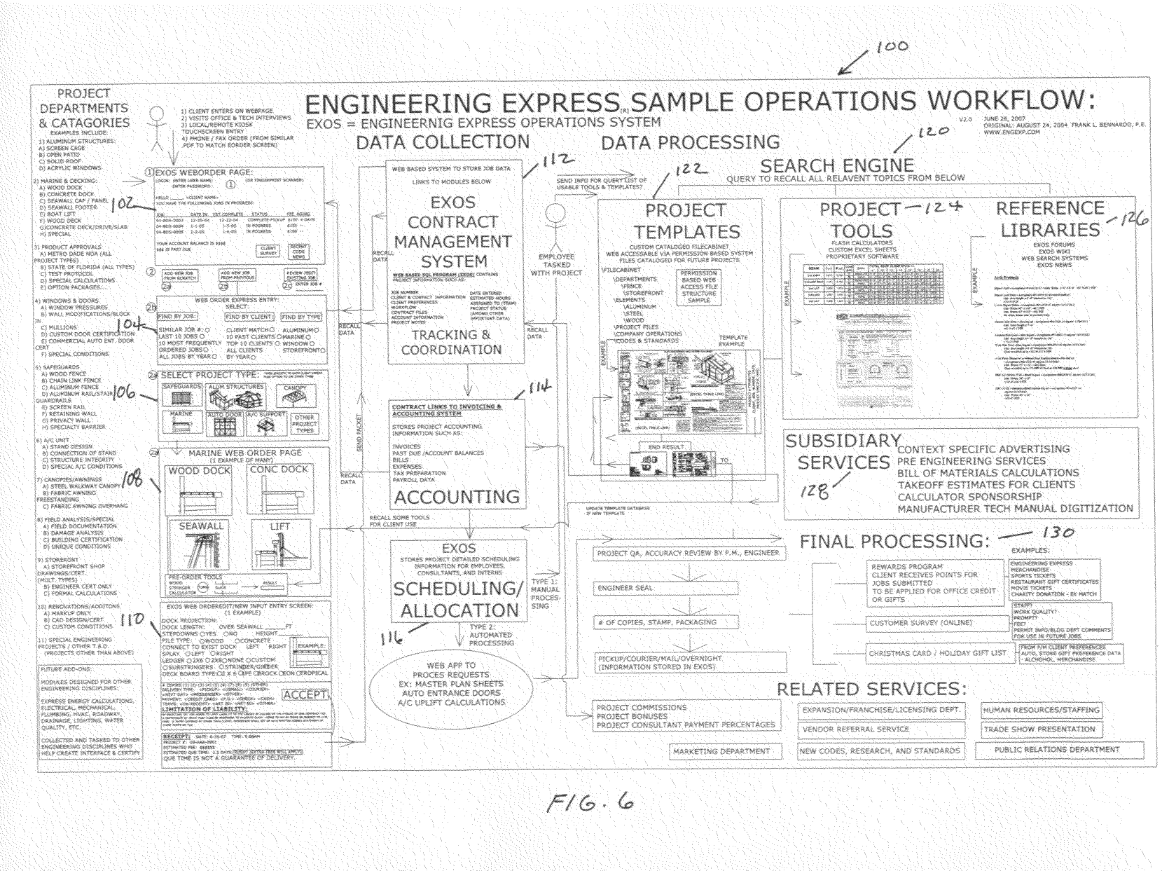

FIG. 6 is a block diagram, generally referenced as 100, for a comprehensive computerized engineering design system in accordance with the present invention. A comprehensive computerized design system in accordance with the present invention is adapted for use by multiple users/accounts over a global computer network. In accordance with this aspect of the present invention users may access, design, and manage specific accounts and projects. The system thus provides a log-in page to provide secure access, which page is generally referenced by block 102. In addition, the system preferably provides the client (once logged in) with search features by job description, client, and/or job type, which page is generally referenced by block 104. The system may further allow customers to select project type, referenced by block 106, and select a project description 108, and data entry screen 110. Further aspects of the system include contract management 112, accounting 114, and scheduling allocation 116. The user further is provided with a search engine 120 capable of directing the user to project templates 122, project tools 124 (including calculators), and reference libraries 126.

A further significant aspect of the present invention relates to providing subsidiary services referenced as 128. In accordance with this aspect of the invention the system may be deployed via Internet connection and kiosk terminals to remote locations, such as home improvement and hardware stores, to facilitate the proper design and engineering of structures, such as fences, decks, and the like by consumers thereby making engineering and design services available to the masses. In accordance with this embodiment, a kiosk located in a retail environment is adapted with computer hardware and Internet connection so as to allow a retail customer the ability to design a system, such as a wood deck, while providing the retail customer with relevant engineering calculations and plans as well as an itemized bill of materials. Finally, the system contemplates final processing services, referenced as 130 wherein a design, having been run through one or more calculators provided in accordance with the teachings of the present invention are electronically presented to a professional engineer for review and approval (e.g. sealing). In accordance with this feature, the user is able to develop a set of engineering plans complete with documented calculations and engineering approval for submission to the appropriate agency to obtain permits, government approvals, variances, and the like.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A computerized engineering design system comprising:
a computer processing system and database;
a plurality of interactive computer based engineering calculators electronically stored on said database;
each calculator including data and formulas electronically processed using a computer spreadsheet application, an interactive data interface, and an integrated development environment so as to provide an interactive graphical user interface;
each calculator including means for prompting and receiving user input; and
each calculator including means for generating engineering output solutions.

2. A computerized engineering design system according to claim 1, wherein said interactive engineering calculators incorporate progressive input functions that customize calculator input prompts and functions based on user input.

3. A computerized engineering design system according to claim 1, wherein said interactive engineering calculators are adapted to provide output identifying approved and non-approved design parameters based on user input.

4. A computerized engineering design system according to claim 1, wherein said computer processing system and data base is connected to a global computer network.

5. A computerized engineering design system according to claim 4, wherein said computer processing system is electronically connected to a plurality of remote computer terminals, each of said terminals adapted for providing user's with remote access to said engineering calculators.

6. A computerized engineering design system according to claim 1, further adapted to coordinate and control secured access by a plurality of users, each with multiple accounts and projects, to provide a source of automated engineering calculation and design services, including project management, job tracking, accounting, scheduling, and final processing services including obtaining the seal of approval by a registered professional engineer.
